(19) United States
(12) Patent Application Publication
(10) Pub. No.: US 2011/0292774 A1
(43) Pub. Date: Dec. 1, 2011

(54) NEAR-FIELD LIGHT EMITTING DEVICE, OPTICAL RECORDING HEAD AND OPTICAL RECORDER

(76) Inventors: Kou Osawa, Hyogo (JP); Koujirou Sekine, Osaka (JP)

(21) Appl. No.: 13/201,284

(22) PCT Filed: Dec. 15, 2009
(86) PCT No.: PCT/JP2009/070892

§ 371 Date: Aug. 12, 2011

(30) Foreign Application Priority Data
Feb. 17, 2009 (JP) 2009-033734

(51) Int. Cl. G11B 13/08; G02B 6/26

(52) U.S. Cl. 369/13.33; 385/31; G9B/13.002

(57) ABSTRACT

Provided is a near-field light emitting device which emits near-field light efficiently by simple structure. A near-field light emitting device comprises a waveguide which is equipped with a core and a clad touching the core and is coupled with light having an electric field component in the direction perpendicular to the boundary surface of the core and clad, and a planar metal structure which is arranged along the above-mentioned boundary surface where the electric field component is in the perpendicular direction. The metal structure has a tip adjoining the light exit surface of the core, and a side projecting to the clad where the width of the metal structure in the direction perpendicular to the propagation direction of the light coupled with the waveguide is wider than the width of the core.

### FIELD OF THE INVENTION

The present invention relates to a near-field light emitting device, optical recording head and optical recorder.

### DESCRIPTION OF RELATED ART

In a magnetic recording system, an increase in the recording density causes the magnetic bit to be subjected to a serious impact from the outdoor temperature and other factors. This requires a recording medium having a high level of coercive force. Use of such a recording medium increases the magnetic field required for recording. The upper limit of the magnetic field produced by the recording head is determined by the saturation magnetic flux density. The value thereof has come close to the limit of the material. Accordingly, a drastic increase cannot be hoped for.

To solve this problem, the following proposal has been made, for example. Magnetic softening is produced by local heating. When the magnetic coercive force has been reduced, recording is started. After that, heating is suspended, and the material is subjected to natural cooling, thereby ensuring the stability of the magnetic bit having been recorded. This is called a thermally assisted magnetic recording method.

In the thermally assisted magnetic recording method, momentary heating of the recording medium is preferred. Thus, it is a common practice to use the absorption of light for heating. Use of light for heating is called the optically assisted method. When extra high density recording is to be achieved by the optically assisted method, the required spot diameter will be about 20 nm. In the normal optical method, this amount of light cannot be converged since there is a limit to diffraction.

To solve this problem, Patent Literatures 1 and 2 propose a method of heating minute regions using the near field light which is non-traveling light. These Patent Literatures employ a minute metal structure (called the plasmon head or plasmon probe) that uses the localized plasmon resonance. The resonance in the plasmon probe can be considered as the resonance of the wave of condensation and rarefaction in the metal traveling electron. The major component of the electric field is perpendicular to the surface of the plasmon probe. For space traveling light, however, the major component of the electric field is perpendicular to the direction of traveling. To ensure efficient excitation of the plasmon probe, light is applied obliquely to the surface of the plasmon probe in the Patent Literature 1. Thus, in the Patent Literature 1, the plasmon probe is held in a tilted position with respect to the magnetic recording medium, without being perpendicular thereto.

In the Patent Literature 2, in the meantime, a plasmon probe is provided along the lateral surface of the core of a waveguide mounted approximately perpendicular to the magnetic recording medium. The light propagating inside the waveguide is deflected toward the plasmon probe by the reflection mirror mounted on the light outgoing end face of the core.

### Earlier Technological Literature

### Patent Literature

Patent Literature 1: Unexamined Japanese Patent Application Publication No. 2005-4901

Patent Literature 2: Unexamined Japanese Patent Application Publication No. 2008-159156

### SUMMARY OF THE INVENTION

### Problems to be Solved by the Invention

However, manufacturing difficulties are involved in holding a plasmon probe in a tilted position as shown in the Patent Literature 1 or in mounting a reflection minor inside the waveguide as shown in the Patent Literature 2. The technique disclosed in these Patent Literatures has failed to ensure sufficient use of the light having expanded in an area wider than the plasmon probe, and has been evaluated to be poor in the efficiency of using light.

In view of the problems described above, it is an object of the present invention to provide a near-field light emitting device that emits near-light efficiently with a simple structure, and an optical recording head and optical recorder equipped with the aforementioned near-field light emitting device.

### Means for Solving the Problems

The aforementioned object of the present invention can be achieved by the following structures:

1. A near-field light emitting device comprising: a waveguide which is equipped with a core and a clad in contact with the core and is coupled with light having an electric field component in a direction perpendicular to a boundary surface between the core and the clad; and a planar metal structure arranged along the boundary surface where the electric field component is in the perpendicular direction; wherein the metal structure has a tip adjoining the light emitting surface of the core, and a side projecting to the clad, wherein a width of the metal structure in a direction perpendicular to a propagation direction of the light coupled with the waveguide is greater than a width of the core.

2. The near-field light emitting device described in Structure 1 wherein the relative refractive index difference Δ is 0.25 or more where the relative refractive index difference Δ is obtained from the following formula based on a refractive index n_{core} of a material of the core and a refractive index n_{clad} of the material of the clad, wherein the core and the clad form the boundary surface along which the metal structure is arranged:

Δ=(n_{core}²−n_{clad}²)/(2×n_{core}²).

3. The near-field light emitting device described in Structure 1 or 2 wherein the aforementioned waveguide is in the single mode when coupled with light.

4. The near-field light emitting device described in any one of the aforementioned Structures 1 to 3 wherein the length of the aforementioned metal structure in the propagation direction is equal to or greater than a wavelength of a surface plasmon generating on a boundary between the core and the metal structure.

5. The near-field light emitting device described in any one of the aforementioned Structures 1 to 4 wherein the metal structure is disposed symmetrically with respect to a center of the core in a width direction of the core.

6. The near-field light emitting device described in any one of the aforementioned Structures 1 to 5 wherein the metal structure is formed in a planar triangle.

7. The near-field light emitting device described in any one of the aforementioned Structures 1 to 5 wherein the metal structure is formed in such a way that the aforementioned tip has a straight portion having a constant width perpendicular to the propagating direction of light. 8. The near-field light emitting device described in any one of the aforementioned Structures 1 to 7 wherein the waveguide has a light spot size converter that reduces the size of the optical spot on an incoming side of the waveguide to guide a wave to a light outgoing surface.

9. A light recording head comprising: the near-field light emitting device described in any one of the aforementioned Structures 1 to 8; and a magnetic recording section for performing magnetic recording on a magnetic recording medium exposed to near-field light by the near-field light emitting device.

10. An optical recorder comprising: a head described in Structure 9; a light source for emitting the light to be coupled with the aforementioned waveguide; a magnetic recording medium wherein magnetic recording is provided by the optical recording head; and a controller for controlling the magnetic recording on the magnetic recording medium by the optical recoding head.

### Advantages of the Invention

According to the present invention, it is possible to provide a near-field light emitting device that emits near-light efficiently by a simple structure, and an optical recording head and optical recorder equipped with the aforementioned near-field light emitting device.

### BRIEF DESCRIPTION OF THE DRAWINGS

FIG. 1 is a diagram representing the approximate structure of an optical recorder provided with an optically assisted magnetic recording head in an embodiment of the present invention;

FIG. 2 is a diagram representing an optical recording head;

FIG. 3 is a perspective view showing the prism constituting an optical recording head;

FIG. 4a is a diagram showing the cross section of the structure of a waveguide, and FIG. 4b is a diagram showing the coordinates for use in the analysis of the waveguide;

FIG. 5 is a diagram showing the amplitude distribution of electric field Ex;

FIG. 6 is a diagram showing the amplitude distribution of electric field Ez;

FIG. 7 is a diagram showing the amplitude distribution of magnetic field Hy;

FIG. 8 is a diagram showing the amplitude distribution of magnetic field Hz;

FIG. 9 is a perspective diagram showing the vicinity of the light outgoing end face of the waveguide equipped with a plasmon probe;

FIG. 10 is a perspective diagram showing the waveguide of FIG. 9 as viewed from the clad;

FIG. 11 is a perspective diagram showing the waveguide of FIG. 9 cut away at the core center position;

FIG. 12a is a diagram showing the electric field intensity distribution in the cross sectional position on surface Z-X at the center across the width of a core, and FIG. 12b is a diagram showing the field intensity distribution at the upper surface position of the plasmon probe parallel to the surface Y-Z;

FIG. 13a is a diagram showing both the core and electric field spot, FIG. 13b is an enlarged view showing the peak of the electric field intensity, and FIG. 13c is a diagram showing the size of the electric field spot;

FIG. 14 is a diagram showing the relationship between the width of the plasmon probe and the width of a core;

FIG. 15 is a diagram illustrating the relationship between the width of a plasmon probe and electric field amplitude factor;

FIG. 16 is a diagram illustrating the length of the plasmon probe;

FIG. 17 is a diagram illustrating the relationship between the length of the plasmon probe and electric field amplitude factor;

FIG. 18 is a diagram showing the model of the two-dimensional slab waveguide;

FIG. 19 is a diagram illustrating the relationship between the relative refractive index difference and normalized frequency wherein the mode field diameter is used as a parameter;

FIG. 20 is a diagram illustrating the relationship between the relative refractive index difference and standardized frequency wherein the ratio between the electric field intensity at the core center and the electric field intensity on the boundary between the core and clad is used as a parameter;

FIG. 21 is a diagram illustrating the process of manufacturing the waveguide provided with a plasmon probe;

FIG. 22 is a diagram illustrating an example of the spot size converter; and

FIG. 23 is a diagram illustrating another example of the shape of a plasmon probe.

### DESCRIPTION OF THE EMBODIMENTS

The following describes the present invention with reference to an optically assisted magnetic recording head wherein the optical recording head as an embodiment of the present invention is equipped with a magnetic recording section, and an optical recorder provided with the aforementioned optically assisted magnetic recording head, without the present invention restricted thereto. For example, the optical recording head as an embodiment of the present invention is also applicable to recording on an optical magnetic medium instead of an optical magnetic recording medium. In the following description, like parts or corresponding parts in various forms of embodiments are designated by the like reference numbers, and a duplicated explanation will be omitted, as appropriate.

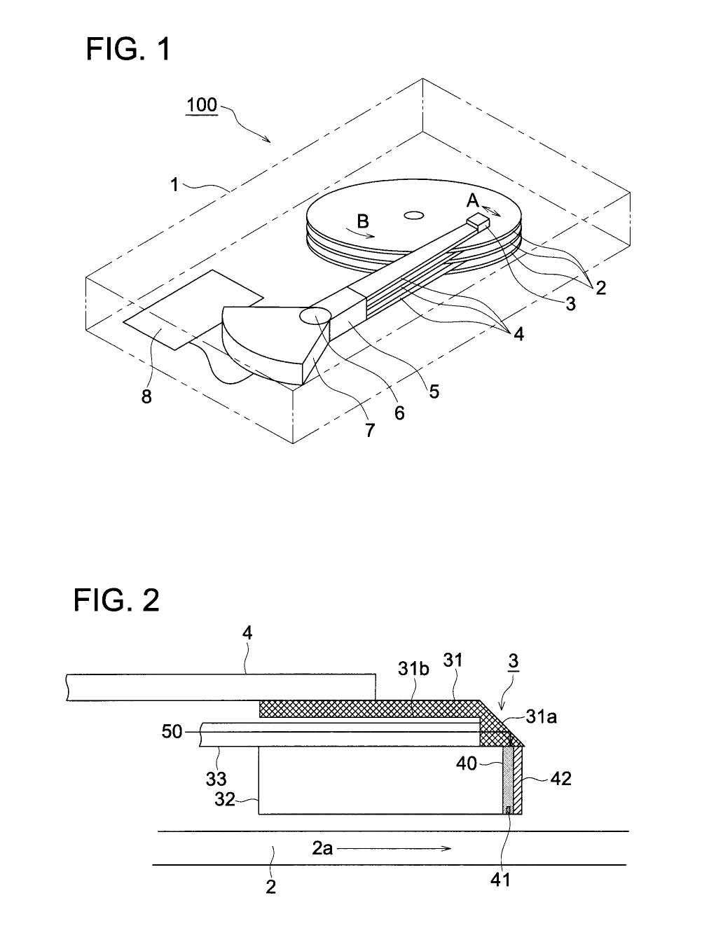

FIG. 1 shows the approximate structure of an optical recorder (e.g., hard disk apparatus) provided with an optically assisted magnetic recording head in the present embodiment. This optical recorder 100 has the following items (1) through (6) incorporated in an enclosure 1:
(1) Recording disk (recording medium) 2
(2) Suspension 4 supported by an arm 5 mounted rotatably in the direction of an arrow A (tracking direction), using the spindle 6 as a fulcrum
(3) Tracking actuator 7 mounted on an arm 5 to drive the arm 5.
(4) Optically assisted magnetic recording head (hereinafter referred to as “optical recording head 3”) mounted on the tip end of a suspension 4 through a connecting member 4a
(5) Motor (not illustrated) for driving the disk 2 in the direction of arrow B
(6) Controller 8 for controlling a tracking actuator 7, motor and optical recording head 3 for producing the magnetic field and the light to be applied in conformance to the writing information to record on the disk 2

The optical recorder 100 is so designed to allow the optical recording head 3 to perform a relative movement while levitating on the disk 2.

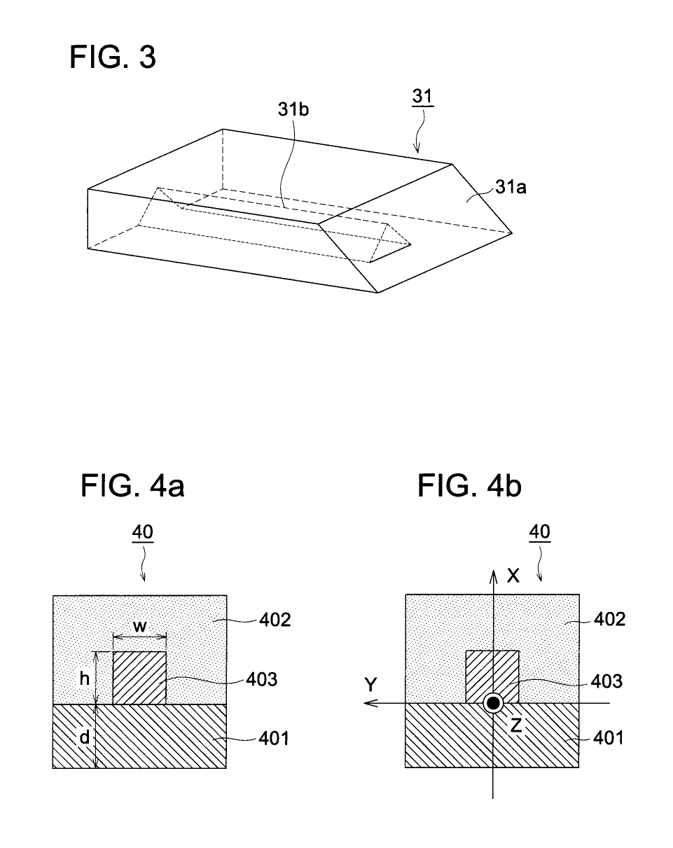

FIG. 2 shows the cross section of an optical recording head 3 as well as the surrounding region. The light 50 emitted from the light source such as a semiconductor laser is led to a slider 32 by an optical fiber 33. The optical fiber 33 is fixed on the upper surface of the slider 32 by the prism 31 (see FIG. 3) equipped with a V-groove 31b for determining the position of an optical axis, and deflecting section 31a. A light guide member of a polymeric waveguide can be used instead of the optical fiber 33. A waveguide 40 and magnetic recording section 42 are provided on the lateral surface of the disk 2 (arrow 2a showing the disk 2 in FIG. 2) in the traveling direction of the disk 2. Although not illustrated in FIG. 2, a magnetic reproduction section for reading the magnetic recording information written onto the disk 2 is provided on each of the outgoing side of the disk 2 with respect to the magnetic recording section 42, and the incoming side of the disk 2 with respect to the waveguide 40.

The light emitted from the optical fiber 33 is deflected by the deflecting section 31a such as a fully reflecting surface and vapor deposited mirror, and is coupled with the waveguide 40 provided on the slider 32. The light coupled with the waveguide 40 is propagated in the direction of the disk 2 and is led to the plasmon probe 41 provided adjacent to the outgoing surface of the waveguide 40. The light having reached the plasmon probe 41 is coupled with the plasmon probe 41 and generates the near-field light at the tip of the plasmon probe 41 exposed at the outgoing surface of the waveguide 40. The minute spot of the generated near-field light heats the disk 2 and reduces the magnetic coercive force of the disk 2. After that, magnetic field is applied by the magnetic recording section 42, whereby magnetic recording is performed.

In FIG. 2, the waveguide 40 and magnetic recording section 42 are arranged in that order from the incoming side of the disk 2 to the outgoing side (in the direction of arrow 2a in FIG. 2). If the magnetic recording section 42 is located immediately after the outgoing side of the disk 2 with respect to the waveguide 40, writing can be preferably started before cooling of the heated recording region goes too far.

FIG. 3 is a perspective view showing the prism 31. The position of the optical fiber 33 relative to the deflecting section 31a of the prism 31 can be determined easily at a high precision by the V-groove 31b. This arrangement ensures that, when the prism 31 is mounted on the slider 32, the light emitted from the optical fiber 33 and deflected by the deflecting section 31a is led to the incoming surface of the waveguide 40 provided on the slider 32.

The thickness of the prism 31 mounted on the upper portion of the slider 32 is preferably 200 μm or less. A small type optical recording head 3 can be obtained by combination between the slider 32 and prism 31. The optical glass or resin material (e.g., polycarbonate and PMMA) can be used as the material of the prism 31.

FIG. 4a shows the cross section of the waveguide 40 in the direction perpendicular to light traveling. The waveguide 40 includes a lower clad 401, prismatic core 403 and upper clad 402. The refractive index of each of the lower clad 401 and upper clad 402 is smaller than that of the material of the prismatic core 403.

In FIG. 4a, “w” is the width of the core 403, “h” is the height of the core 403, and “d” is the thickness of the lower clad 401. The coordinates for the sake of explanation are given in FIG. 4b. Assume that the Z-axis is the axis (vertical to the sheet surface) passing through the center across the width of the boundary surface between the lower clad 401 and core 403; the Y-axis is the axis that runs through the Z-axis within the surface perpendicular to the Z-axis and is parallel to the boundary surface between the lower clad 401 and core 403; and the X-axis is the axis that runs through the crossing point between the Z- and Y-axes, and is perpendicular to the boundary surface between the lower clad 401 and core 403.

The refractive index of the core 403 is represented by n_{core}, and the refractive index is shown by n_{clad} wherein the upper clad 402 and lower clad 401 are assumed to be made of the same material. In this example, the upper clad 402 and lower clad 401 have the same refractive index. However, the refractive index need not be the same. The upper clad 402 and lower clad 401 may have different refractive indices. The following formula (1) shows the definition of the relative refractive index difference z that indicates the characteristics of the waveguide 40 in this case.

Δ=(n_{core}²−n_{clad}²)/(2×n_{core}²) (1)

The specific material of the waveguide 40 and the refractive index thereof are shown below in the format of “Material (refractive index)”. In the communication wavelength range having wavelengths of 1.5 μm and 1.3 μm, Si (3.48) can be used as the material of the core 403, and SiO (1.4 through 3.48) or Al₂O₃ (1.8) can be used as the material of the clad (lower clad 401 and upper clad 402). In these materials, the relative refractive index difference Δ can be designed in the range from 0.001 through 1.42.

In the visible range wherein the wavelength is in the range from 400 through 800 nm, GaAs (3.3) or Si (3.7) can be used as the material of the core 403. Ta₂O₅ (2.5) or SiOx (1.4 through 3.7) can be used as the material of the clad. For these materials, the relative refractive index difference Δ can be set in the range from 0.001 through 0.41.

The materials of high refractive index (wavelength range) that can be used to produce a core are exemplified by diamond (visible range); III-V Group semiconductor, AlGaAs (near-infrared, red), GaN (green, blue), GaAsP (red, orange blue), GaP (red, yellow, green), InGaN (bluish green, blue) and ALGaInP (orange, yellowish orange, yellow, green); II-VI Group semiconductor, ZnSe (blue). The other thin layer materials of low refractive index that can be used as the material of the clad include silicon carbide (sic), calcium fluoride (CaF), silicon nitride (Si₃N₄), titanium oxide (TiO₂) and diamond (C).

Without being restricted to the aforementioned materials, free designing of the relative refractive index difference Δ can be achieved to some extent by changing the structural refractive index by a combination of the materials such as TiO₂, SiN and ZnSe or by use of photonic crystal structures. It should be noted that, for the purpose of definition of the relative refractive index difference Δ, the theoretically possible range of Δ is in the range from 0 through 0.5.

In the optical fiber of single mode used in a long desistance optical communication, SiO₂ formed by doping Ge is used as a core material, and SiO₂ is used as the material of the clad. By adjusting the doped amount of Ge, the relative refractive index difference Δ is designed to be about 0.003. In the commonly used step type optical fiber in the single mode, the mode field diameter (MFD) is about 10 μm when the wavelength is 1.5 μm.

In 1 T bit/in² high-density magnetic recording, the diameter of the recording region on the disk 2 is about 25 nm. Thus, when using near-field light for forming a minute optical spot, the optical spot in the waveguide 40 (mode field diameter) is preferably reduced, for example, to about 0.5 μm or less. To reduce the mode field diameter, the relative refractive index difference Δ must be increased. The relative refractive index difference A obtained from the core material and clad material forming the boundary along which the plasmon probe is arranged is preferably 0.25 or more.

In an example of the waveguide 40 for reducing the mode field diameter down to about 0.5 μm, a waveguide 40 having a relative refractive index difference Δ of about 0.4 was assumed when the wavelength is 1.5 μm, and the electric field distribution of this waveguide was analyzed. In a specific example for this analysis, Si (n_{core}=3.48) was used as the material of the core 403, and SiO₂ (n_{clad}=1.44) was used as the materials of the upper clad 402 and lower clad 401. From the aforementioned refractive index, the relative refractive index difference Δ is calculated as 0.41. For the width w and height h of the core, w=h=300 nm was assumed.

The waveguide 40 having the aforementioned structure is a single mode waveguide of the TM mode that meets the single mode requirements for a preferred waveguide, wherein the electric field vibration of the light to be coupled is oriented in the X-axis direction. The waveguide meeting the single mode requirements is suited for high-speed transmission of the optical signal, and is characterized by excellent temporal stability of the magnetic intensity distribution inside the waveguide at the time of coupling with light. The X-axis direction is perpendicular to the boundary surface formed by the core 403 and lower clad 401 and the upper clad 402, as shown in FIG. 4.

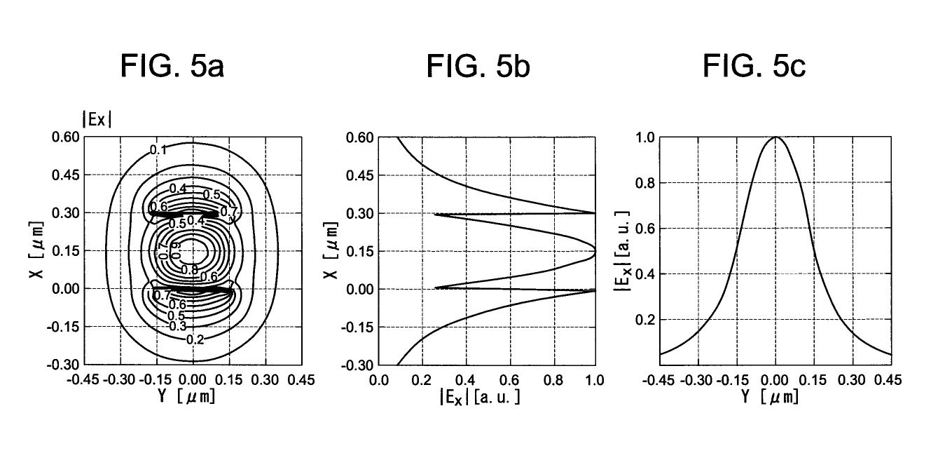

FIGS. 5 through 8 show the result of mode analysis of the TM single mode waveguide 40 provided with the structure of FIG. 4 as described above. Analysis was made according to the Finite Differential Method (FDM). The major components of the electric field are Ex and Ez, and the major components of magnetic field are Hy and Hz.

FIG. 5A represents the amplitude of the electric field Ex in terms of contour line. FIG. 5B shows the profile of the electric field |Ex| on the X-Z cross section of Y=0 in FIG. 5A. FIG. 5C shows the profile of the electric field |Ex| on the cross section parallel to the Y-Z surface passing through the peak of the electric field |Ex| in the vicinity of X=0.15 μm in FIG. 5A. Both the contour line and profile are represented by the normalized values wherein the maximum amplitude value (in absolute terms) is 1. FIGS. 5A and 5B show distribution of a strong electric field |Ex| in the vicinity of the boundary between the core 403, upper clad 402 and lower clad 401. The intensity of the electric field generating to the clad portion near the boundary is increased with the relative refractive index difference Δ.

In the distribution of the electric field on the cross section in the X-axis direction of FIG. 5B, a large discontinuous portion is present in the vicinity of the boundary between the core 403, upper clad 402 and lower clad 401. It can be seen that presence of a discontinuous portion is:

ε_{core}×E_{core}=ε_{clad}×E_{clad} (2)

for E_{core} on the core side and E_{clad} on the clad side of the X component of the electric field on the boundary from the following formula (2)

n_{core}²×E_{core}=n_{clad}²×E_{clad} (3)

as a boundary requirement of the component perpendicular to the boundary surface derived from the Maxwell's equation.

In this case, ε_{core} denotes the relative permittivity of the core. ε_{core} is ε_{core}=n_{core}² when the refractive index of the dielectric core is n_{core}. Similarly, ε_{clad} is the relative permittivity of the clad. ε_{clad} is ε_{clad}=n_{core}² when the refractive index of the dielectric clad is n_{clad}. When the refractive index used in this analysis is substituted,

E_{clad}/E_{core}=n_{core}²/n_{clad}²=1/(1−2×Δ)=5.55

This exhibits almost complete agreement with the reading from the chart of FIG. 5B. The relationship between E_{core} and E_{clad} can be obtained from the formula (2) without using the FDM method.

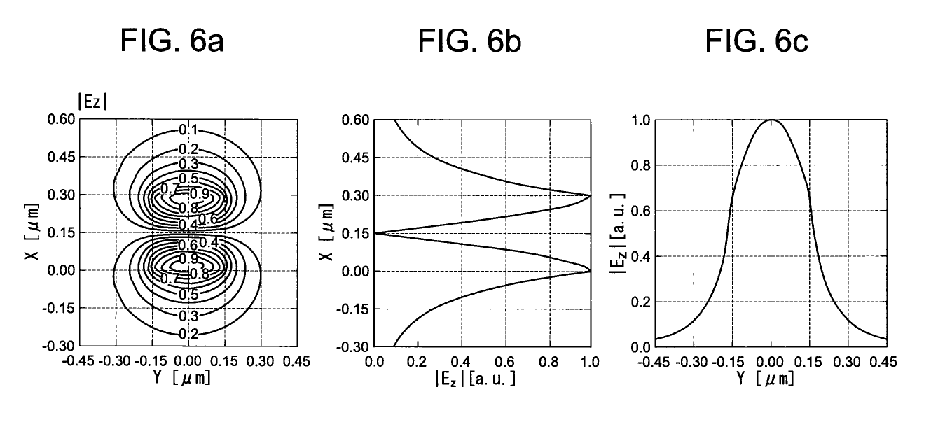

FIG. 6A indicates the amplitude of the electric field Ez in terms of contour line. FIG. 6B shows the profile of the electric field |Ez| on the X-Z cross section of Y=0 in FIG. 6A. FIG. 6C shows the profile of the electric field |Ez| on the cross section parallel to the Y-Z surface passing through the peak of the electric field |Ez| in the vicinity of X=0 (or X=0.3 μm) in FIG. 6A. Both the contour line and profile are represented in terms of normalized values wherein the maximum amplitude value (absolute value) is “1”. FIGS. 6A, 6B and 6C suggest that a powerful electric field |Ez| is distributed close to the boundary between the core 403, upper clad 402 and lower clad 401. The intensity of the electric field generating to the clad portion close to the boundary increases with the relative refractive index difference Δ.

The result of mode analysis of the electric fields Ex and Ez demonstrates that a high electric field intensity can be obtained on the clad side close to the boundary between the core 403, lower clad 401 and upper clad 402.

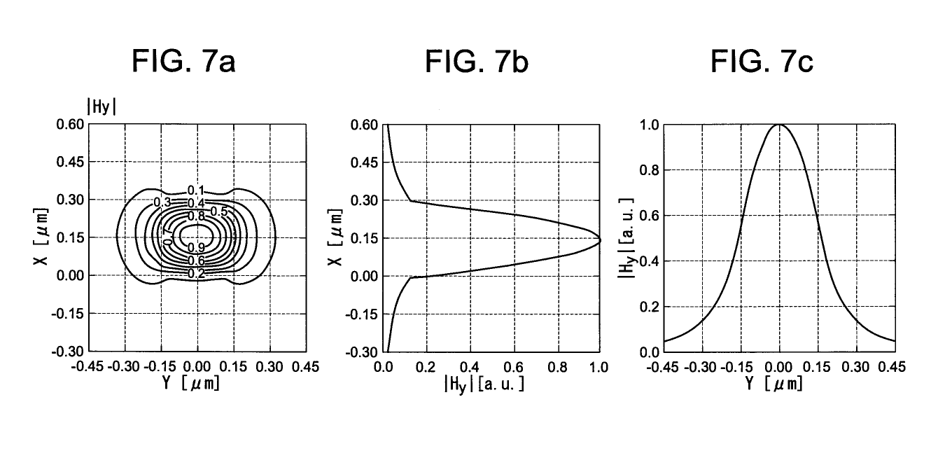

FIG. 7A illustrates the amplitude of the magnetic field Hy in terms of contour line. FIG. 7B shows the profile of the magnetic field |Hy| on the X-Z cross section of Y=0 in FIG. 7A. FIG. 7C shows the profile of the magnetic field |Hy| on the cross section parallel to the Y-Z surface passing through the peak of the magnetic field |Hy| in FIG. 7A. Both the contour line and profile are represented by the normalized values wherein the maximum amplitude value (in absolute teens) is 1. FIGS. 7A, 7B and 7C show distribution of a strong magnetic field |Hy| in the vicinity of the boundary between the core 403, upper clad 402 and lower clad 401. The intensity of the electric field generating to the clad portion near the boundary is increased with the relative refractive index difference Δ.

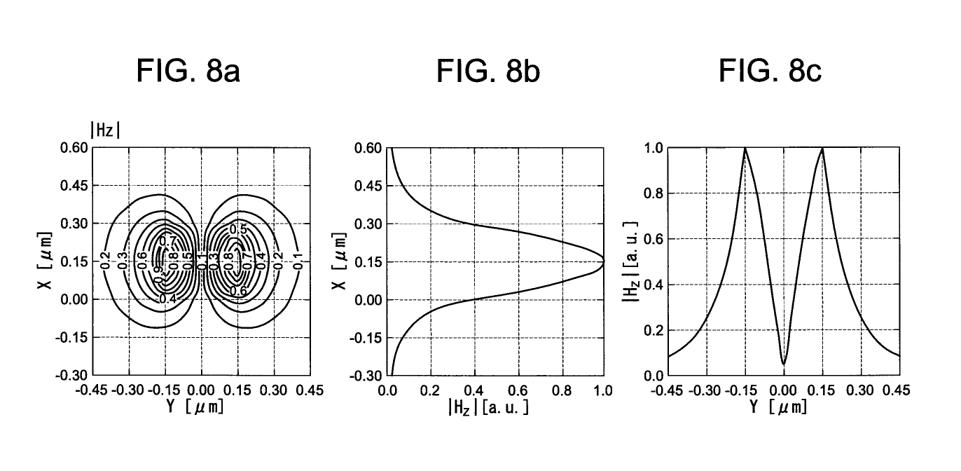

FIG. 8A illustrates the amplitude of the magnetic field Hz in terms of contour line. FIG. 8B shows the profile, for example, in the vicinity of Y=−0.15 μm in the magnetic field |Hz| on the X-Z cross section passing through the peak of magnetic field |Hz| of FIG. 8A. FIG. 8C shows the profile of the magnetic field |Hz| on the cross section parallel to the Y-Z surface passing through the peak of the magnetic field |Hz| in FIG. 8A. Both the contour line and profile are represented by the normalized values wherein the maximum amplitude value (in absolute terms) is 1. FIGS. 8A, 8B and 8C show distribution of a strong magnetic field |Hz| in the vicinity of the boundary between the core 403, upper clad 402 and lower clad 401. The intensity of the magnetic field generating to the clad portion near the boundary is increased with the relative refractive index difference Δ.

The mode field diameter shown in FIG. 5C is calculated as 380 nm in terms of the overall width at 1/e position of the electric field |Ex| in the Y direction. It has been confirmed that the desired value of 0.5 μm or less can be obtained. It is possible to get a small optical spot diameter of about 25 nm that allows high-density magnetic recording of 1 Tbit/in² to be achieved by combining a plasmon probe with the waveguide 40 wherein the light of the plasmon probe having been discussed so far is coupled in the single mode. The following describes the structure wherein the plasmon probe 41 is combined with the waveguide 40.

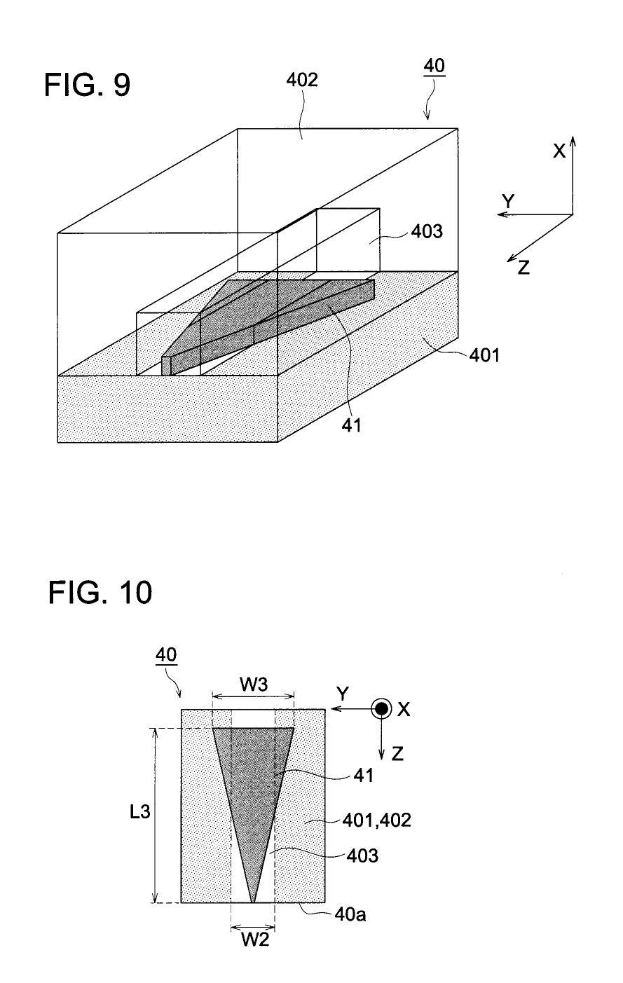

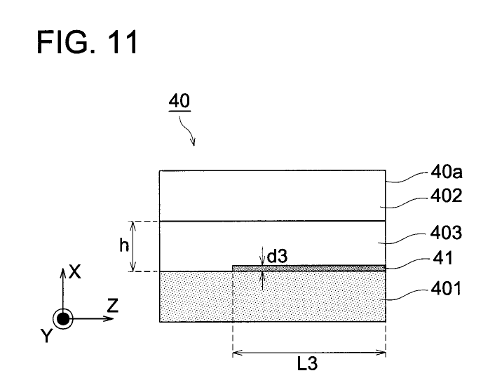

FIG. 9 is a perspective diagram showing the vicinity of the light outgoing end face of the waveguide 40 equipped with a plasmon probe 41. The following shows the result of analysis made by using this structure. FIG. 10 is a perspective diagram showing FIG. 9 as viewed from the upper clad 402. FIG. 11 is a cross sectional view of the Z-X surface at the center of the core 403 in FIG. 9. The structure of the waveguide 40 is the same as that of FIG. 4. The plasmon probe 41 is provided on the upper surface of the lower clad 401.

The plasmon probe 41 is designed in a triangular planar metal structure symmetric with respect to the Z-X surface passing through the center across the width in the Y direction of the core 403. Gradually becoming sharper toward the tip end surface (light outgoing end surface) of the waveguide 40, the plasmon probe 41 has the tip exposed to the tip end surface 40a. An upper clad 402 is provided so as to cover the plasmon probe 41 and lower clad 401. The plasmon probe 41 is arranged along the boundary between the core 403 and lower clad 401.

The arrangement of the plasmon probe 41 along the boundary between the core 403 and lower clad 401 ensures efficient coupling with the electro-magnetic field component that is concentrated on the boundary between the core 403 and lower clad 401, as described with reference to FIGS. 8 through 11.

To ensure the electro-magnetic field component to be concentrated on the boundary between the core 403 and lower clad 401, the light to be coupled with the waveguide preferably has an electric field component perpendicular to the boundary surface, and this component is preferably greater. The TM mode is used for coupling of light with the waveguide.

The plasmon probe 41 of a triangular shape gradually becomes sharper toward the tip end surface 40a. The energy coupled with the plasmon probe 41 propagates toward the tip end surface 40a of the waveguide as the surface plasmon. The energy is concentrated on the fine tip end to generate the near-field light.

The width W3 of the plasmon probe 41 is greater than the width W2 of the core. The plasmon probe 41 travels across the core 403 and projects toward the upper clad 402 from both ends of the core 403. This structure enables coupling with the light traveling inside the core 403 and covering the entire area of width W2. This structure prevents the unintended region of the disk 2 from being exposed to the light emitted from the tip end surface 40a of the waveguide 40 without being coupled with the plasmon probe 41. This ensures stable recording.

Thus, the width W3 of the plasmon probe 41 is set at 400 nm, which is greater than the width W2 of the core (300 nm). The width of the tip end of the plasmon probe 41 is set at 10 nm, with consideration given to high magnetic recording density.

The material of the plasmon probe 41 is gold (Au), which provides a preferable material. Gold exhibits a high electric field enhancement factor (to be described later) for the light of all wavelengths. Further, gold is impervious to oxidation. Other materials include aluminum (Al), copper (Cu) and silver (Ag). These elements are characterized by a high electric field enhancement factor m, and are preferably used as the material of a plasmon probe.

Further, platinum, rhodium, palladium, ruthenium, iridium and osmium can also be mentioned as the materials that are characterized by excellent thermal and chemical properties, and are impervious to oxidation even at a high temperature. These elements do not cause a chemical reaction with the materials of the clad and core. The aforementioned materials among metals are characterized by smaller thermal conductivity. When these materials are used, heat generated close to the tip end of the plasmon probe is not easily transferred to the surrounding area. Thus, these materials are suited to producing a thermally assisted head.

The thickness d of the plasmon probe 41 made of gold (refractive index: 0.559 through 9.81 i) was set to 20 nm, based on the thickness dₛ of the surface layer expressed by the following formula (4) which is calculated from the imaginary part x of the refractive index of a metal:

dₛ=1/(κ×k₀) (4)

wherein k₀ denotes the number of waves in vacuum

The length L3 of the plasmon probe 41 is preferably greater than the wavelength λₛₚ of the surface plasmon defined by the following Formulas (5) through (9).

$$\begin{matrix}[ Mathematical Formula 1 ] & \\ {k}_{sp} = {k}_{0} \sqrt{\frac{1}{\frac{1}{{ɛ}_{m}^{′}} + \frac{1}{{ɛ}_{1}}}} = {{k}_{0} ( \frac{1}{\frac{1}{{ɛ}_{m}^{′}} + \frac{1}{{ɛ}_{1}}} )}^{\frac{3}{2}} \frac{{ɛ}_{m}^{″}}{2 {( {ɛ}_{m}^{′} )}^{2}} i & ( 5 ) \\ [ Mathematical Formula 2 ] & \\ {k}_{0} = \frac{2 π}{{λ}_{0}} & ( 6 ) \\ [ Mathematical Formula 3 ] & \\ {ɛ}_{m} = {ɛ}_{m}^{′} + i {ɛ}_{m}^{″} & ( 7 ) \\ [ Mathematical Formula 4 ] & \\ {λ}_{sp} = \frac{2 π}{Re [ {k}_{sp} ]} & ( 8 ) \\ [ Mathematical Formula 5 ] & \\ {L}_{1 / e} = \frac{1}{Im [ {k}_{sp} ]} & ( 9 )\end{matrix}$$

wherein
kₛₚ: Number of waves of the surface plasmon defined by a complex number;
k₀: Number of waves in vacuum;
εm: Complex relative permittivity of a metal; and
ε1: Permittivity of a dielectric.

The permittivity of a dielectric ε1 corresponds to the relative permittivity of the core in the waveguide 40 as a dielectric. The number of waves of the surface plasmon is based on the “Basics and Application of Surface Plasmon” (K. Nagashima, J. Plasma Fusion Res. Vol. 84, No. 1 (2008)).

The wavelength λₛₚ of the surface plasmon running through the boundary between the Si core (refractive index: 3.48) and gold at a wavelength of 1.5 μm can be calculated as 403 nm from the formula (8). Thus, to ensure excellent functions as a plasmon probe of a waveguide structure, the length of the plasmon probe 41 is preferably 403 nm or more.

Since 7.8 μm is the length L_{1/e} wherein the amplitude of the electric field estimated by using the imaginary part of the number of waves kₛₚ of the surface plasmon of Formula (5) is reduced to 1/e, the upper limit of the length of the plasmon probe 41 is preferably approximately 8 μm or less. Particularly, the plasmon probe 41 is preferably kept at approximately 8 μm or less in radius from the tip.

If there is an increase in the distance to the tip end of the plasmon probe 41 from where light is coupled with the plasmon probe, there is also an increase in the loss when the surface plasmon having generated at the position of light coupling is propagated to the tip end. Thus, the size of the plasmon probe 41 (e.g., length L3 or width W3) is preferably greater as the surface wherein the surface plasmon is excited. However, if the length L3 or width W3 is excessive, the traveling loss will be excessive. Then generation of near-field light in conformity to the size cannot be expected. With consideration given to this, the length L3 of the plasmon probe 41 has been set to 1.0 μm.

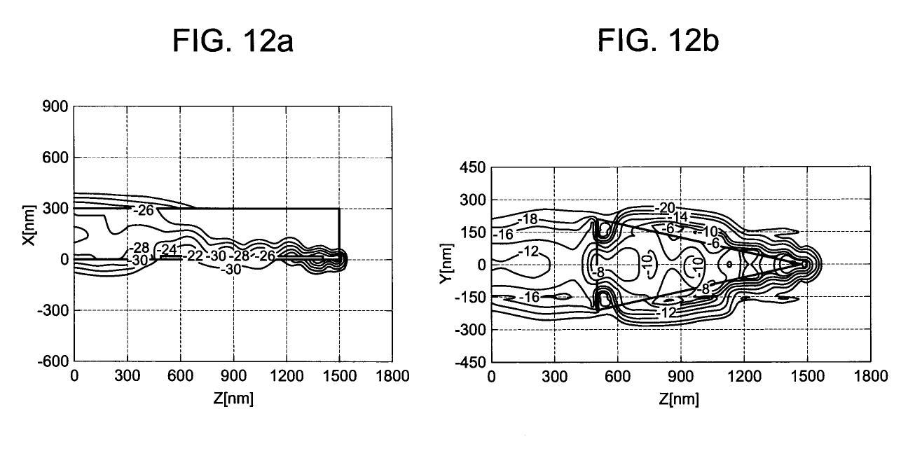

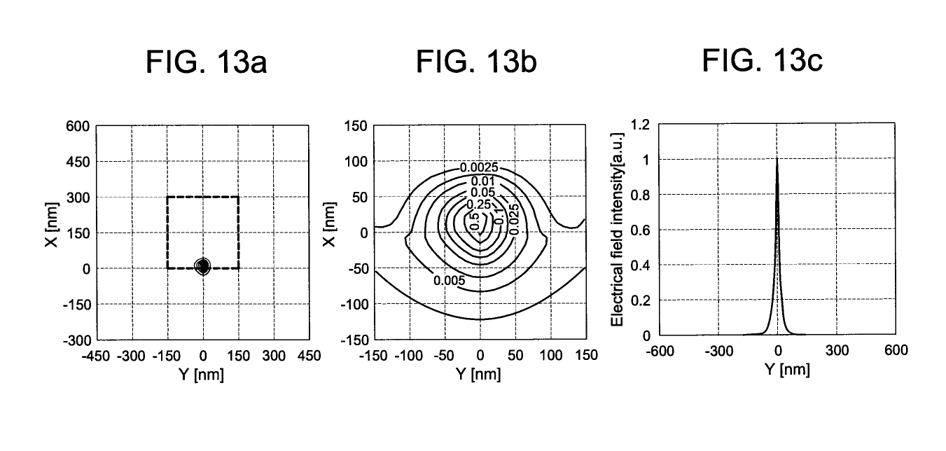

FIGS. 12 and 13 show the result of analyzing the electric field in the waveguide 40 equipped with the plasmon probe 41 using the FDTD (Finite Differential Time Domain Method) under the aforementioned conditions. FIG. 9 shows the setting of the coordinate axes in this analysis. X is assigned along the thickness of the lower clad 401 and upper clad 402, Y is assigned across the width of the core 403, and Z is assigned in the propagation direction of light. Note that light travels in the +Z direction.

FIGS. 12a and 12b show the distribution of the electric field intensity in the longitudinal direction (Z direction) that is the propagation direction of light in the plasmon probe 41. When the highest intensity value at the tip end is used as a reference, and is set at 0 dB, the electric field intensity of FIG. 12 is shown in the relative value thereof (dB value).

FIG. 12a shows the distribution of the electric field intensity at the cross sectional position of the plasmon probe 41 parallel to the Z-X plane at the center of the width W3 of the core 403. FIG. 12b shows the distribution of the electric field intensity at each of the surface positions (the boundary surface between the core 403 and plasmon probe 41) of the plasmon probe 41 parallel to the Y-Z plane.

In FIG. 12a, the region inside the portion surrounded by a square belongs to the core 403. X=0 indicates the boundary position with the core 403 in contact with the lower clad 401. Z=1500 nm indicates the position of the tip end surface 40a of the waveguide 40. In FIG. 12a, as the electric field inside the core 403 travels toward the tip end of the waveguide 40, the electric field can be observed to converge gradually at the plasmon probe 41 arranged on the boundary between the core 403 and lower clad 401.

In FIG. 12b, the position Y=±150 nm corresponds to the boundary between the core 403 and upper clad 402. The plasmon probe 41 has a width W3 of 400 nm and is projecting by 50 nm from the region of the core 403 in both the positive and negative directions. Arrangement of an extensive plasmon probe 41 straddling the boundary between the core 403 and dads (lower clad 401 and upper clad 402) described above ensures complete use of the electromagnetic field components concentrated on the boundary between the core 403 and clads (lower clad 401 in particular), with the result that effective excitation of the surface plasmon is achieved. This enables efficient generation of the near-field light at the tip of the plasmon probe 41.

FIGS. 13a through 13c illustrate the distribution (|E|²) of the electric field intensity 10 nm away from the tip end surface 40a of the waveguide 40. FIG. 13a shows the view from the plasmon probe 41. This diagram shows both the core 403 and electric field spot. The region indicated by the dotted line frame illustrates the outer periphery of the core 403. FIG. 13b is an enlarged view close to the peak of the electric field intensity in FIG. 13a. FIG. 13c illustrates the profile of the electric field intensity distribution passing through the peak of the electric field intensity.

The size of the optical spot evaluated in terms of the full width at half maximum of the profile of the electric field intensity distribution given in FIG. 13c is 20 nm. This is suited for high-density magnetic recording of 1 Tbit/in².

The electric field enhancement factor m represents the ratio of the electric field intensity in the presence of a plasmon probe 41 with reference to the electric field intensity in the absence of a plasmon probe 41. The electric field enhancement factor m is defined by the following formula (10):

m=|E₁/E₀|² (10)

wherein Eo indicates the electric field peak value at the tip end surface 40a in the absence of a plasmon probe 41, and E₁ indicates the electric field peak value at the tip end surface 40a in the presence of a plasmon probe 41.

The electric field enhancement factor m in the aforementioned optical spot wherein the full width at half maximum is 20 nm is approximately 30. This suggests a high-density concentration of the electric field. The electric field component on the peripheral area except where the aforementioned optical spot is formed does not exceed −20 dB. This demonstrates concentration of an electric field characterized by an excellent S/N ratio wherein the region except for a specified portion is not heated.

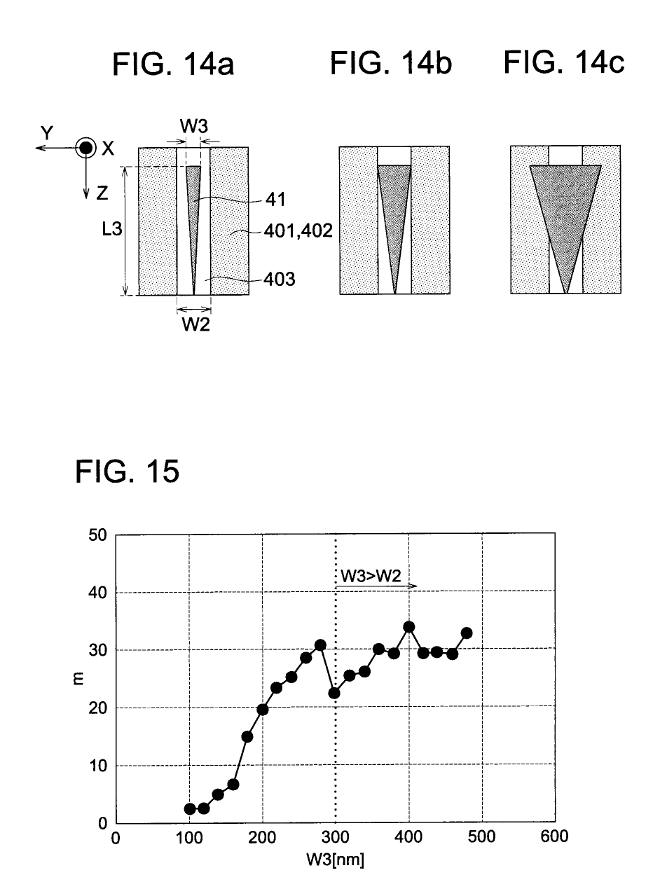

Referring to FIGS. 14 and 15, the following describes the relationship between the electric field enhancement factor m and the width W3 of the plasmon probe 41. FIG. 14 shows that the width W3 is changed while the length of the plasmon probe 41 is kept unchanged. FIG. 15 illustrates the result of obtaining the electric field enhancement factor m in each case.

FIG. 14a shows the case wherein W3<W2. The entire plasmon probe 41 is included in the core 403. FIG. 14b shows the case wherein W3=W2. The width W3 of the plasmon probe 41 and width W2 of the core 403 are equal with each other. FIG. 14C shows the case wherein W3>W2. The width W3 of the plasmon probe 41 is greater than the width W2 of the core 403.

FIG. 15 illustrates the electric field enhancement factor m when the width W3 of the plasmon probe 41 is plotted on the horizontal axis, and is changed, while the width W2 of the core 403 (300 nm) is kept unchanged. It can be seen that, when the width W3 of the plasmon probe 41 is greater than the width W2 of the core 403, there is little change of the electric field enhancement factor m when W3 has changed.

In the meantime, in the region wherein the core 403 of the plasmon probe 41 is equal or smaller than the width W2 of the core 403 (W3≦W2), the electric field enhancement factor m reduces as the width W3 decreases. There is an increase in the percentage of the change in the electric field enhancement factor m with reference to the change of W3. The sensitivity to the change in width W3 is also increased. When the width W3 does not exceed 150 nm, there is almost no coupling of light. When the width W3 does not exceed 100 nm, light is not coupled with the plasmon probe 41 per se.

As described above, the width W3 of the plasmon probe 41 is greater than the width W2 of the core 403 and the plasmon probe 41 projects to the upper clad 402 from both sides of the core 403. This structure allows changes in the electric field enhancement factor m to be minimized with reference to the fluctuation of the width W3. This increases the permissible error of the width W3 when the plasmon probe 41 is produced, and allows a structure suited for high-volume production.

Further, the plasmon probe 41 is preferably configured to pass through the center of the core 403 and to be symmetric with respect to the Z-X plane. The symmetric configuration minimizes the fluctuation of the electric field enhancement factor in resulting from the displacement with respect to the core 403 at the time of production.

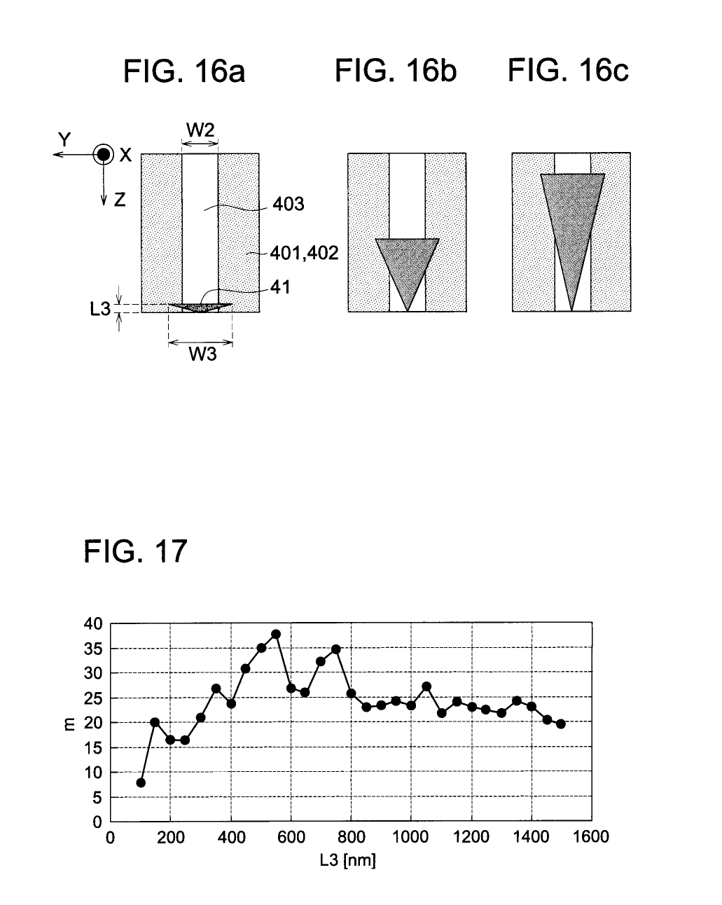

Referring to FIGS. 16 and 17, the following describes the relationship between the length L3 of the plasmon probe 41 and electric field enhancement factor m. The structures of the plasmon probe 41 and waveguide 40 are the same as those analyzed with reference to FIGS. 12 and 13, except for the difference in the length L3 of the plasmon probe 41. FIG. 16 shows the positional relationship between the waveguide 40 and plasmon probe 41. The width W2 of the waveguide 40 is 300 nm. The width W3 of the plasmon probe 41 is greater than the width W2, and is constant at 500 nm. The length L3 was changed to obtain the electric field enhancement factor m. This result is illustrated in FIG. 17.

When the length L3 of the plasmon probe 41 does not exceed 400 nm, the electric field enhancement factor m exhibits a linear change with respect to the change in the length L3. As the length L3 is reduced, the electric field enhancement factor m decreases.

As the length L3 is reduced, the electric field enhancement factor m decreases. This will be because the surface area of the plasmon probe 41 is reduced, and the electric field components to be coupled are reduced, as a result. Further, when L3 is close to 150 nm, 350 nm, 550 nm or 750 nm, the electric field enhancement factor m is observed to be accompanied by local peaks. This will be due to the resonance corresponding to each of L3=λₛₚ/2, λₛₚ, 3×λₛₚ/2, 2×λₛₚ, since the wavelength λₛₚ of the surface plasmon calculated by formula (8) is 403 nm. If the length L3 of the plasmon probe 41 is too small, interference is considered to occur between the progressive wave of the surface plasmon in the plasmon probe 41 and the reflected wave coming back after having been reflected twice at the end face. This is assumed to create a resonance peak.

In the region wherein the length L3 of the plasmon probe 41 is equal to or greater than the wavelength λₛₚ (λₛₚ=403 nm), there is only a small reduction in the electric field enhancement factor m even if the length L3 has exceeded 1500 nm. Especially in the region of twice the wavelength λₛₚ of the surface plasmon (λₛₚ=806 nm) or more, a change in the electric field enhancement factor m with respect to length L3 is small.

As the length L3 of the plasmon probe 41 is increased, the local peak becomes invisible. This will be because the reflected wave is damped before the coupled surface plasmon comes back to the tip end by reflection, and the size of the component is so reduced that the interference is minimized.

Thus, to ensure a certain magnitude (e.g., about 20) of the electric field enhancement factor m, the length L3 of the plasmon probe is preferably greater than the wavelength of the surface plasmon. When the length L3 of the plasmon probe is made greater than twice the wavelength of the surface plasmon, it is possible to reduce changes in the electric field enhancement factor m with respect to the length L3 of the plasmon probe 41. This procedure reduces changes in the electric field enhancement factor m caused, for example, by the production error of the plasmon probe 41. This preferably provides easy production of the waveguide that ensures stable near-field light.

To enhance containment of light and to reduce the coupled optical spot in the waveguide 40, the relative refractive index difference Δ defined in Formula (1) is preferably equal to or greater than 0.25. If the relative refractive index difference Δ is equal to or greater than 0.25, the concentration of the electric field on the boundary between the core and clad having been discussed so far can be made more conspicuous. If the plasmon probe 41 is arranged along this boundary surface, the electric field (light) is efficiently coupled with the plasmon probe 41, and more efficient generation of near-field light will be achieved.

The following describes the relative refractive index difference Δ. For the mode distribution analysis using the two-dimensional slab waveguide as a mode in this description, reference has been made to “Photonics Series, Basics of Light Waveguide” (K. Okamoto, Corona Publishing Co., Ltd, 1992).

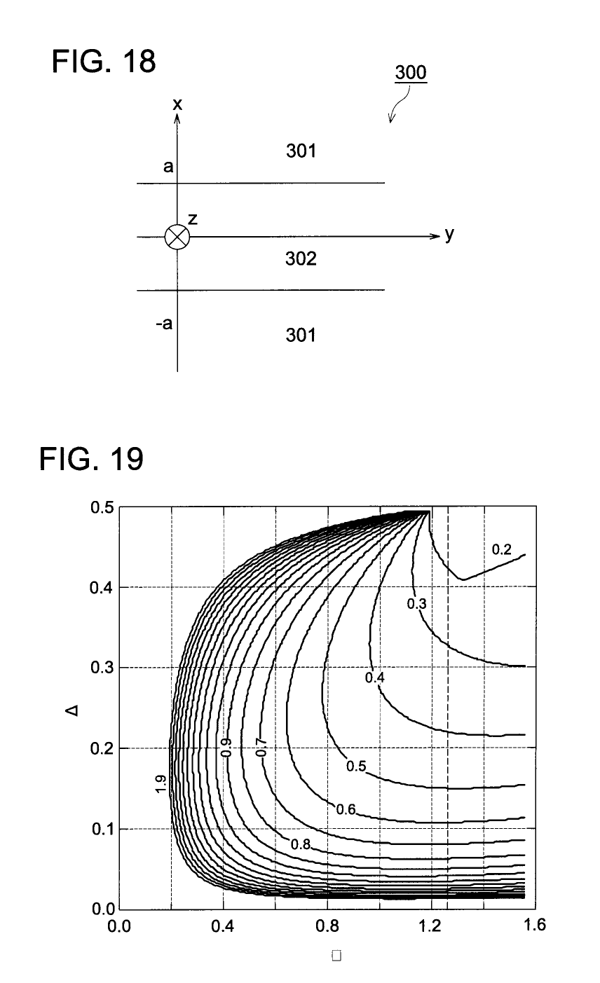

In the two-dimensional slab waveguide 300 as a model for analysis given in FIG. 18, the following Formulas (11) through (17) provide the analytical solutions of the TM-order mode (Hy, Ex and Ez) of the triple-layer symmetric slab waveguide wherein the refractive index of the clad 301 is “nₒ”, that of the core 302 is “n₁” and the width of the core is “2a”

$$\begin{matrix}[ Mathematical Formula 6 ] & \\ {u}^{2} + {w}^{2} = {v}^{2} = ( {n}_{1}^{2} - {n}_{0}^{2} ) {k}_{0}^{2} {a}^{2} = 2 {Δ ( {n}_{1} {k}_{0} a )}^{2} & ( 11 ) \\ [ Mathematical Formula 7 ] & \\ w = \frac{{n}_{0}^{2}}{{n}_{1}^{2}} u tan ( u - \frac{m π}{2} ) = ( 1 - 2 Δ ) u tan ( \frac{u - m π}{2} ) & ( 12 ) \\ [ Mathematical Formula 8 ] & \\ v = {n}_{1} {k}_{0} a \sqrt{2 Δ} , \\ Δ = \frac{{n}_{1}^{2} - {n}_{0}^{2}}{2 {n}_{`1}^{2}} ( ≅ \frac{{n}_{1} - {n}_{0}}{{n}_{1}} for {n}_{1} ∼ {n}_{0} ) & ( 13 ) \\ [ Mathematical Formula 9 ] & \\ {β}^{2} = \frac{1}{2} ( {n}_{1}^{2} + {n}_{0}^{2} ) {k}_{0}^{2} - \frac{{u}^{2} - {w}^{2}}{{a}^{2}} , \\ φ = \frac{m π}{2} & ( 14 ) \\ [ Mathematical Formula 10 ] & \\ {H}_{y} = \{ \begin{matrix}A cos ( u - φ ) exp [ - \frac{w}{a} ( x - a ) ] & a < x \\ A cos ( \frac{u}{a} x - φ ) & x \leq \vert a \vert \\ A cos ( - u - φ ) exp [ - \frac{w}{a} ( - x - a ) ] & x < - a\end{matrix} & ( 15 ) \\ [ Mathematical Formula 11 ] & \\ {E}_{x} = \{ \begin{matrix}\frac{β}{ω {ɛ}_{0}} A \frac{1}{{n}_{0}^{2}} cos ( u - φ ) exp [ - \frac{w}{a} ( x - a ) ] & a < x \\ \frac{β}{ω {ɛ}_{0}} A \frac{1}{{n}_{1}^{2}} cos ( \frac{u}{a} x - φ ) & x \leq \vert a \vert \\ \frac{β}{ω {ɛ}_{0}} A \frac{1}{{n}_{0}^{2}} cos ( - u - φ ) exp [ - \frac{w}{a} ( - x - a ) ] & x < - a\end{matrix} & ( 16 ) \\ [ Mathematical Formula 12 ] & \\ {E}_{z} = \{ \begin{matrix}\frac{j}{{ωɛ}_{0}} \frac{w}{a} A \frac{1}{{n}_{0}^{2}} cos ( u - φ ) exp [ - \frac{w}{a} ( x - a ) ] & a < x \\ \frac{j}{{ωɛ}_{0}} \frac{u}{a} A \frac{1}{{n}_{1}^{2}} sin ( \frac{u}{a} x - φ ) & x \leq \vert a \vert \\ - \frac{j}{{ωɛ}_{0}} \frac{w}{a} A \frac{1}{{n}_{0}^{2}} cos ( - u - φ ) exp [ - \frac{w}{a} ( - x - a ) ] & x < - a\end{matrix} & ( 17 )\end{matrix}$$

In the aforementioned Formulas, “k₀” indicates the number of waves in vacuum. Parameters u and w are uniquely determined by the relative refractive index difference Δ and standardized frequency, using the aforementioned formulas. v<π/2 is the cut-off condition wherein only one waveguide mode is present. The following describes the case of the lowest order (m=0) mode as v<π/2.

FIG. 19 shows the result of obtaining the relationship between the relative refractive index difference Δ and standardized frequency v, when the wavelength λ is 1.5 μm and core refractive index n₁ is 3.48, wherein the mode field diameter is used as a parameter.

In FIG. 19, it is apparent that, when the relative refractive index difference Δ is 0.4 or more, there is an abrupt change of the mode field diameter with respect to standardized frequency v, at the standardized frequency v below the cut-off condition. This shows that, in the waveguide wherein the relative refractive index difference Δ is 0.4 or more, the mode field diameter is minimized close to the single mode condition. To put it more specifically, to minimize the mode field diameter in the single mode waveguide wherein the relative refractive index difference Δ is 0.25 or more, the core width is preferably in the range from about 0.8 through 1.0 times the core width at the time of cut-off (v=π/2) (indicated by a broken line in FIG. 19).

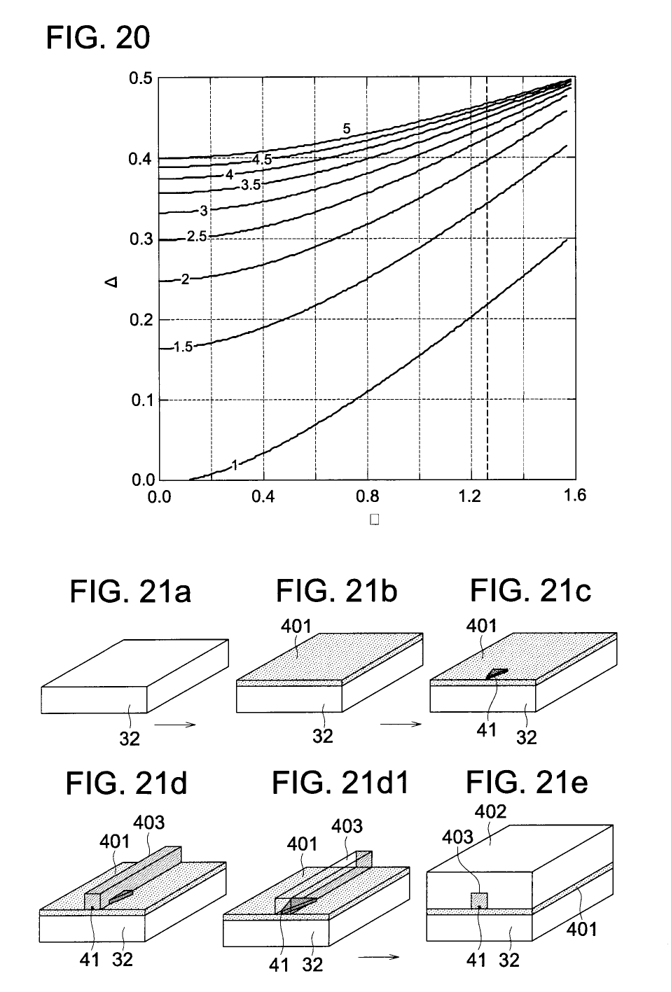

FIG. 20 shows the result of obtaining the relationship between the relative refractive index difference Δ and standardized frequency v wherein the ratio between the electric field intensity at the center of the core (Ex (x=0)) and the electric field intensity on the clad side (Ex (x=a+0) on the boundary with the clad is used as a parameter. When the standardized frequency v preferred to minimize the mode field diameter is in the range from 0.8 through 1.0 times the standardized frequency v during the cut-off time as shown in FIG. 19, FIG. 20 shows that, to ensure that the electric field intensity in the clad region is equal to or greater than that at the center of the core (electric field intensity E_{R}=1), it is sufficient that the relative refractive index difference Δ is 0.25 or more. Thus, the relative refractive index difference Δ between the clad 301 and core 302 constituting the waveguide is preferably 0.25 or more.

Referring to FIG. 21, the following describes the process of producing the waveguide 40 and plasmon probe 41. A film of lower clad 401 made of a material of low-refractive index such as SiO₂ is formed on the slider 32 (FIG. 21B), wherein the substrate supporting the waveguide 40 is used as a slider 32 (FIG. 21A). Then a plasmon probe 41 made of such a metal as gold is formed on the lower clad 401 (FIG. 21C). A positioning mark can be formed simultaneously with formation of the plasmon probe 41.

In the next step, the core 403 made of a material of high refractive index such as Si is superimposed on the plasmon probe 41 (FIG. 21D). In the final phase, the entire core 403 and lower clad 401 are covered with the upper clad 402 made of a material of low refractive index such as SiOx (FIG. 21E). FIG. 21D1 shows the plasmon probe 41 formed on the lower clad 401, as viewed through the formed core 403.

The aforementioned production method allows the waveguide 40 to be manufactured to a high precision, using a commonly known method such as photolithography or etching. The plasmon probe 41 is a planer structure arranged on the upper surface of the lower clad 401. There is no need of setting a special angle. The plasmon probe 41 can be manufactured easily by the ion milling method or lift-off method.

The diameter of the mode field of the waveguide 40 shown in FIG. 4 is 380 nm at a wavelength of 1.5 μm. Thus, the optical pot size must be reduced to ensure efficient coupling of the waveguide 40 with the light led by a general single mode optical fiber wherein the mode field diameter is about 10 μm. Generally, to ensure the maximum optical coupling efficiency, the spot size of the light coupling with the waveguide must be made to conform to the mode field diameter of the waveguide. In this case, the tolerance of misregistration for ensuring 90 percent or higher efficiency is equal to or less than 0.2 times the mode field diameter. A high positioning accuracy of 0.1 μm or less is required to ensure that the optical spot having the same spot size is aligned with the waveguide wherein the relative refractive index difference A of the waveguide 40 is as great as 0.2 or more, for example, and the mode field diameter is 0.5 μm or less.

In such cases, the waveguide 40 is preferably provided with an optical spot size converter. This minimizes the coupling loss when the light coupled with the waveguide 40 has a greater spot diameter, and increases the tolerance of positioning between the optical spot at the incoming end of the waveguide and the waveguide. At the same time, the optical spot diameter can be reduced to about 0.5 μm so that effective coupling with the plasmon probe and effective generation of the near-field light can be achieved.

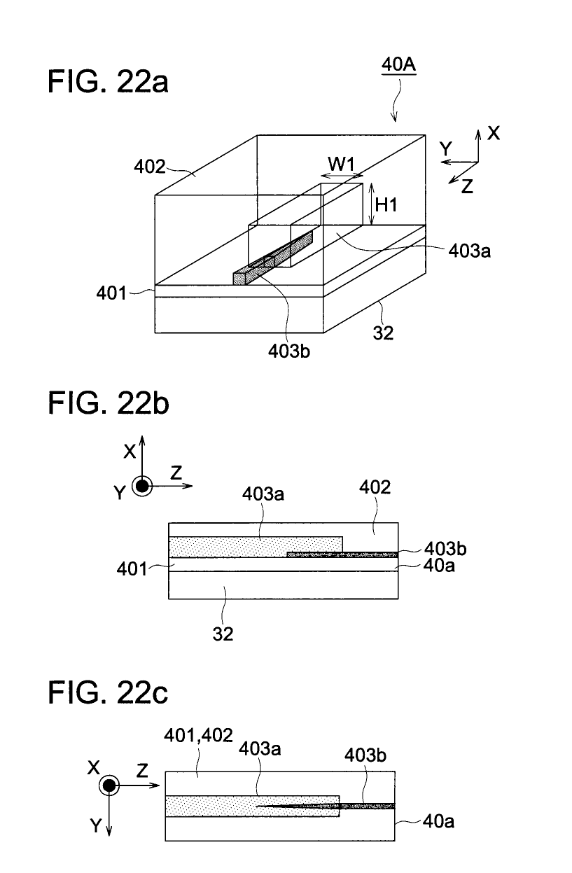

FIG. 22 shows the structure of a waveguide 40A provided with an optical spot size converter. For ease of understanding, the plasmon probe is not illustrated. In FIG. 22, light travels in the +Z direction. An outer core 403a is mounted on the light incoming end of the Si-made thin-wired core 403b of the waveguide 40, wherein this outer core 403a has a refractive index lower than that of the thin-wired core 403b and higher than that of the clads (lower clad 401 and upper clad 402). The optical spot size is gradually reduced as the waveguide 40A moves in the direction wherein light travels. To produce the outer core 403a, it is only necessary to select the material made of the SiOx having a refractive index higher than that of the clad, within the range, for example, from 1.4 through 3.48.

The height of the thin-wired core 403b (thickness in X direction) is constant from the light incoming side to the incoming side, as the Z-X cross section passing through the center of the Si thin-wired core 403b in the Y-axis direction of FIG. 22B. Further, the width of the thin-wired core 403b (Y direction) is gradually reduced as one goes toward the light incoming side from the light outgoing side of the SiOx-made outer core 403a, as shown in the perspective diagram of the waveguide 40A from the upper clad 402 side in FIG. 22C. The diameter of the mode field is converted by this gradual change in the core width. This thin-wired core 403b corresponds to the core 403 in FIG. 9. A plasmon probe is arranged on the boundary between this thin-wired core 403b and lower clad 401.

FIG. 22C shows the width of the tapered portion of the thin-wired core 403b. The width on the light incoming side is 0.1 μm or less, and that on the light outgoing side is 0.3 μm. In the meantime, a waveguide having a mode field diameter of about 5 μm is formed on the light incoming side by the outer core 403a having a width of W1 and a height of H1. The optical spot with a mode field diameter of about 5 μm coming from the incoming side undergoes light-coupling so as to be concentrated on the thin-wired core 403b gradually from the outer core 403a, with the result that the mode field diameter is reduced. On the light outgoing side, the mode field diameter is converted into an optical spot of about 0.5 μm.

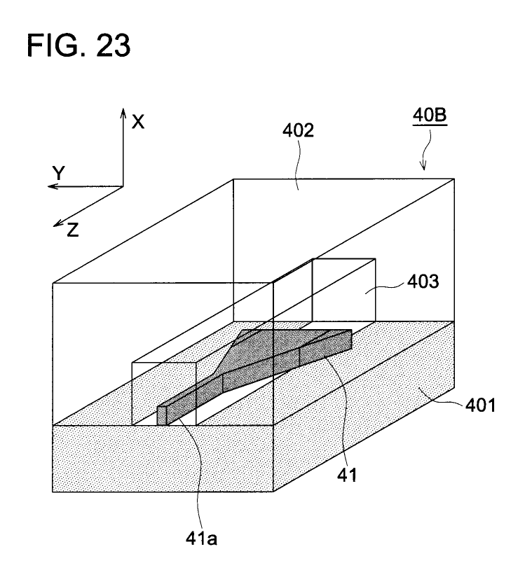

FIG. 23 shows another example of the plasmon probe. This plasmon probe is characterized by a structure 41a wherein the constricted portion is stretched in the Z direction on the tip end in the light propagation direction, with the width remaining unchanged. To be more specific, this plasmon probe has, on the tip, a straight portion of a constant width in the directions (both X and Y directions) perpendicular to the light propagation direction. This arrangement ensures the state of constriction (width of the structure 41a) to be kept unchanged, even if the tip of the plasmon probe is prolonged or shortened by a manufacturing error in the X direction. Further, there is no change in the width of the tip of the plasmon probe, even if the surface (slider bottom surface) on the light outgoing side has been ground, with the plasmon probe arranged on the slider. This provides easy production of a plasmon probe capable of efficient generation of near-field light, without being affected by manufacturing errors.

The embodiment described so far relates to an optically assisted magnetic recording head and an optically assisted magnetic recorder. The major components of the embodiment can be used to produce an optical recording head or optical recorder wherein an optical recording disk is used as the recording medium. In this case, the magnetic recording section 42 and magnetic reproducing section mounted on the slider 32 are not necessary.

1-10. (canceled)

11. A near-field light emitting device comprising:
a waveguide which is equipped with a core and a clad in contact with the core and is coupled with light having an electric field component in a direction perpendicular to a boundary surface between the core and the clad; and
a planar metal structure arranged along the boundary surface where the electric field component is in the perpendicular direction; wherein the metal structure has a tip adjoining the light emitting surface of the core, and a side projecting to the clad, wherein a width of the metal structure in a direction perpendicular to a propagation direction of the light coupled with the waveguide is greater than a width of the core.

12. The near-field light emitting device described in claim 11 wherein a relative refractive index difference Δ is 0.25 or more where the relative refractive index difference Δ is obtained from the following formula based on a refractive index n_{core} of a material of the core and a refractive index n_{clad} of the material of the clad, wherein the core and the clad form the boundary surface along which the metal structure is arranged:
Δ=(n_{core}²−n_{clad}²)/(2×n_{core}²).

13. The near-field light emitting device described in claim 11 wherein the waveguide is in the single mode when coupled with light.

14. The near-field light emitting device described in claim 11 wherein a length of the metal structure in the propagation direction is equal to or greater than a wavelength of a surface plasmon generating on a boundary between the core and the metal structure.

15. The near-field light emitting device described in claim 11 wherein the metal structure is disposed symmetrically with respect to a center of the core in a width direction of the core.

16. The near-field light emitting device described in claim 11 wherein the metal structure is formed in a planar triangle.

17. The near-field light emitting device described in claim 11 wherein the metal structure is formed in such a way that the tip has a straight portion having a constant width perpendicular to the propagating direction of the light.

18. The near-field light emitting device described in claim 11 wherein the waveguide has a light spot size converter that reduces a size of an optical spot on an incoming side of the waveguide to guide a wave to a light outgoing surface.

19. An optical recording head comprising:
the near-field light emitting device described in claim 11; and
a magnetic recording section for performing magnetic recording on a magnetic recording medium exposed to near-field light by the near-field light emitting device.

20. An optical recorder comprising:
the optical recording head described in claim 19;
a light source for emitting a light to be coupled with the waveguide;
a magnetic recording medium wherein magnetic recording is performed by the optical recording head; and
a controller for controlling the magnetic recording on the magnetic recording medium by the optical recording head.
